(19) United States
(12) Patent Application Publication
(10) Pub. No.: US 2024/0280863 A1
(43) Pub. Date: Aug. 22, 2024

(54) PHASE GRATING LIQUID CRYSTAL (PGLC) DEVICE AND METHOD OF MANUFACTURING THE SAME

(71) Applicant: CORNING INCORPORATED, CORNING, NY (US)

(72) Inventor: Jae-won Huh, Asan-city (KR)

(21) Appl. No.: 18/571,802

(22) PCT Filed: Jun. 16, 2022
(86) PCT No.: PCT/US2022/033707

§ 371 Date: Dec. 19, 2023

(30) Foreign Application Priority Data
Jun. 22, 2021 (KR) 10-2021-0081104

(51) Int. Cl. G02F 1/1343; G02F 1/137

(52) U.S. Cl. CPC G02F 1/13439; G02F 1/134363; G02F 1/1375

(57) ABSTRACT

Provided is a phase grating liquid crystal (PGLC) device including a transparent substrate; a first electrode on the transparent substrate; a second electrode on the transparent substrate; and a liquid crystal (LC) layer on the first and second electrodes; wherein the first electrode includes a first bus line, and a plurality of first branch electrodes connected to the first bus line, and a plurality of second branch electrodes connected to the second bus line, and wherein the first and second electrodes are at the same level with respect to the transparent substrate.

### BACKGROUND

### 1. Cross-Reference to Related Applications

This application claims the benefit of Korean Patent Application No. 10-2021-0081104, filed on Jun. 22, 2021, in the Korean Intellectual Property Office, the disclosure of which is incorporated herein in its entirety by reference.

### 2. Field

The inventive concept relates to a phase grating liquid crystal (PGLC) device and a method of manufacturing the same.

### 3. Description of the Related Art

Recently, smart windows which can change their optical properties in response to external energy, such as heat, light, and electricity, have been actively studied. Various types of smart windows have been proposed, such as electro-chromic smart windows, suspended-particle smart windows, and liquid crystal (LC) smart windows. Among these, LC smart windows have received much attention due to their unique properties of switching between a transparent state and translucent state, fast response time, etc. A polymer dispersed LC (PDLC) device has been widely used for providing privacy depending on the situation. However, the PDLC device has several disadvantages, such as low transmittance in a transparent state, a high operating voltage, and limitation of application due to an initially translucent state. To overcome these disadvantages of the PDLC device, a phase grating LC (PGLC) device have been suggested. The PGLC device has superior operating performance, such as a wide dynamic range of haze (˜90%), viewing angle independence, low driving voltage.

### SUMMARY

Provided are a phase grating liquid crystal (PGLC) device including electrodes of a single layer type and a method of manufacturing the PGLC device.

Additional aspects will be set forth in part in the description which follows and, in part, will be apparent from the description, or may be learned by practice of the presented embodiments of the disclosure.

According to an aspect of the inventive concept, there is provided a PGLC (phase grating liquid crystal) device. The PGLC (phase grating liquid crystal) device comprises a transparent substrate, a first electrode on the transparent substrate, a second electrode on the transparent substrate, and a liquid crystal (LC) layer on the first and second electrodes.

In some embodiments, the first electrode includes a first bus line extending in a first direction parallel to an upper surface of the transparent substrate, and a plurality of first branch electrodes connected to the first bus line.

In some embodiments, the second electrode includes a second bus line extending in the first direction, and a plurality of second branch electrodes connected to the second bus line.

In some embodiments, the first and second electrodes are at the same level with respect to the transparent substrate.

In some embodiments, the first and second electrodes are configured to form a periodic electric field over the entire transparent substrate.

In some embodiments, the first and second electrodes are configured to form a periodic liquid crystal alignment distribution over the liquid crystal layer.

In some embodiments, a first supply voltage is applied to the first electrode, and a second supply voltage less than the first voltage is applied to the second electrode.

In some embodiments, the PGLC device is in a hazy state by applying the first and second power voltages.

In some embodiments, each of the first and second electrodes contacts the transparent substrate.

In some embodiments, the first and second bus lines are spaced apart from each other with the plurality of first branch electrodes and the plurality of second branch electrodes interposed therebetween.

In some embodiments, the PGLC device include only a single cell composed of the first and second electrodes.

In some embodiments, each of the plurality of first branch electrodes and the plurality of second branch electrodes extends along a second direction perpendicular to the first direction and parallel to an upper surface of the transparent substrate.

In some embodiments, the plurality of first branch electrodes and the plurality of second branch electrodes are alternately arranged along the first direction.

In some embodiments, the transparent substrate includes a straight edge oblique with respect to the second direction.

In some embodiments, the transparent substrate includes a straight edge perpendicular to the second direction.

In some embodiments, each of the plurality of first branch electrodes and the plurality of second branch electrodes has a triangular wave structure.

In some embodiments, each of the plurality of first branch electrodes and each of the plurality of second branch electrodes has a comb structure.

In some embodiments, each of the plurality of first branch electrodes and each of the plurality of second branch electrodes has a wavy structure.

In some embodiments, each of the plurality of first branch electrodes includes first portions and second portions alternately connected to each other.

In some embodiments, the first portions and the second portions are oblique with respect to each other.

In some embodiments, the first portions and second portions are perpendicular to each other.

According to an aspect of the inventive concept, there is provided a method of manufacturing a phase grating liquid crystal device (PGLC). The method comprises depositing a transparent electrode material layer on a transparent substrate, and patterning, through a metal lithography process, the transparent electrode material layer to form first and second electrodes.

In some embodiments, the first electrode includes a first bus line extending in a first direction parallel to an upper surface of the transparent substrate, and a plurality of first branch electrodes connected to the first bus line.

In some embodiments, the second electrode includes a second bus line extending in the first direction, and a plurality of second branch electrodes connected to the second bus line.

In some embodiments, the first and second electrodes are formed simultaneously.

In some embodiments, of the plurality of first branch electrodes and each of the plurality of second branch electrodes extends along a second direction perpendicular to the first direction and parallel to an upper surface of the transparent substrate.

In some embodiments, the plurality of first branch electrodes and the plurality of second branch electrodes are alternately arranged along the first direction.

In some embodiments, each of the plurality of first branch electrodes and each of the plurality of second branch electrodes has a triangular wave.

According to an aspect of the inventive concept, there is provided a PGLC (phase grating liquid crystal) device. The PGLC (phase grating liquid crystal) device comprises a transparent substrate, a first and second electrodes and on the transparent substrate, and a liquid crystal (LC) layer formed on the first and second electrodes.

In some embodiments, the first electrode includes a first bus line extending along a first portion of an outline of the transparent substrate and a plurality of first branch electrodes connected to the first bus line.

In some embodiments, the second electrode includes a second bus line extending along a second portion of the outline of the transparent substrate and a plurality of first branch electrodes connected to the first bus line.

In some embodiments, the plurality of first branch electrodes extend towards the second bus line, and the plurality of second branch electrodes extend towards the first bus line.

In some embodiments, the plurality of first branch electrodes and the plurality of second branch electrodes are alternately arranged.

In some embodiments, an upper surface of the transparent substrate has a rectangular shape.

In some embodiments, an upper surface of the transparent substrate has a polygonal shape.

In some embodiments, an upper surface of the transparent substrate has a circular shape.

In some embodiments, a horizontal area between the first and second bus lines is more than 90% of an area of an upper surface of the transparent substrate

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a plan view illustrating a phase grating liquid crystal (PGLC) device according to example embodiments;

FIG. 2 is a cross-sectional view taken along the cut line AA-AA′ of FIG. 1;

FIG. 3 and FIG. 4 are schematic drawings for explaining an operation mechanism of the PGLC device according to example embodiments;

FIG. 5 is a partial plan view illustrating one of the plurality of first branch electrodes and one of the plurality of second branch electrodes according to example embodiments;

FIGS. 6A to 6D are graphs for explaining effects according to dimensions one of the first and second branch electrodes and liquid crystal layer according to example embodiments;

FIG. 7 is a plan view illustrating a PGLC device according to other example embodiments;

FIG. 8 is a plan view illustrating the PGLC device according to other example embodiments;

FIG. 9 is a plan view illustrating a PGLC device according to other example embodiments;

FIG. 10 is a plan view illustrating a PGLC device according to other example embodiments;

FIG. 11A is a partial plan view illustrating a plurality of first branch electrodes and a plurality of second branch electrodes according to other example embodiments;

FIG. 11B illustrates distribution of alignment directions of liquid crystal molecules;

FIG. 12A is a partial plan view illustrating a plurality of first branch electrodes and a plurality of second branch electrodes according to other example embodiments;

FIG. 12B illustrates distribution of alignment directions of liquid crystal molecules;

FIG. 13A is a partial plan view illustrating a plurality of first branch electrodes and a plurality of second branch electrodes according to other example embodiments;

FIG. 13B illustrates distribution of alignment directions of liquid crystal molecules;

FIG. 14 is a partial plan view illustrating a plurality of first branch electrodes and a plurality of second branch electrodes according to other example embodiments;

FIG. 15 illustrates a change in haze according to the magnitude of the voltage applied between the first and second branch electrodes;

FIG. 16 illustrates a change in specular transmittance according to the magnitude of the voltage applied between the first and second branch electrodes;

FIG. 17 is a flowchart illustrating a method of manufacturing a PGLC device according to example embodiments;

FIG. 18 is a plan view illustrating a method of manufacturing a PGLC device according to example embodiments.

### DETAILED DESCRIPTION

The disclosure will now be described more fully with reference to the accompanying drawings, in which example embodiments are shown. The subject matter of the disclosure may, however, be embodied in many different forms and should not be construed as being limited to the example embodiments set forth herein. Rather, these embodiments are provided so that the disclosure will convey the subject matter to those skilled in the art. In the drawings, the thicknesses of layers and regions may be exaggerated for clarity. Wherever possible, like reference numerals in the drawings will denote like elements. Therefore, the disclosure is not limited by relative sizes or intervals as shown in the accompanied drawings.

While such terms as “first,” “second,” etc., may be used to describe various components, such components are not limited to the above terms. The above terms are used only to distinguish one component from another. For example, a first component may indicate a second component or a second component may indicate a first component without conflicting.

The terms used herein in various example embodiments are used to describe example embodiments only, and should not be construed to limit the various additional embodiments. Singular expressions, unless defined otherwise in contexts, include plural expressions. The terms “comprises” or “may comprise” used herein in various example embodiments may indicate the presence of a corresponding function, operation, or component and do not limit one or more additional functions, operations, or components. It will be further understood that the terms “comprises” and/or “comprising,” when used in this specification, may be used to specify the presence of stated features, integers, steps, operations, elements, and/or components, but do not preclude the presence or addition of one or more other features, integers, steps, operations, elements, components, and/or groups thereof. Also, expressions such as “at least one of”, when preceding a list of elements, modify the entire list of elements and do not modify the individual elements of the list.

When a certain embodiment may be implemented differently, a specific process order may be performed differently from the described order. For example, two consecutively described processes may be performed substantially at the same time or performed in an order opposite to the described order.

Variations from the shapes of the illustrations as a result, for example, of manufacturing techniques and/or tolerances, are to be expected. Thus, embodiments of the disclosure should not be construed as limited to the particular shapes of regions illustrated herein, but are to include deviations in shapes that result, for example, from manufacturing. As used herein, the term “and/or” includes any and all combinations of one or more of the associated listed items.

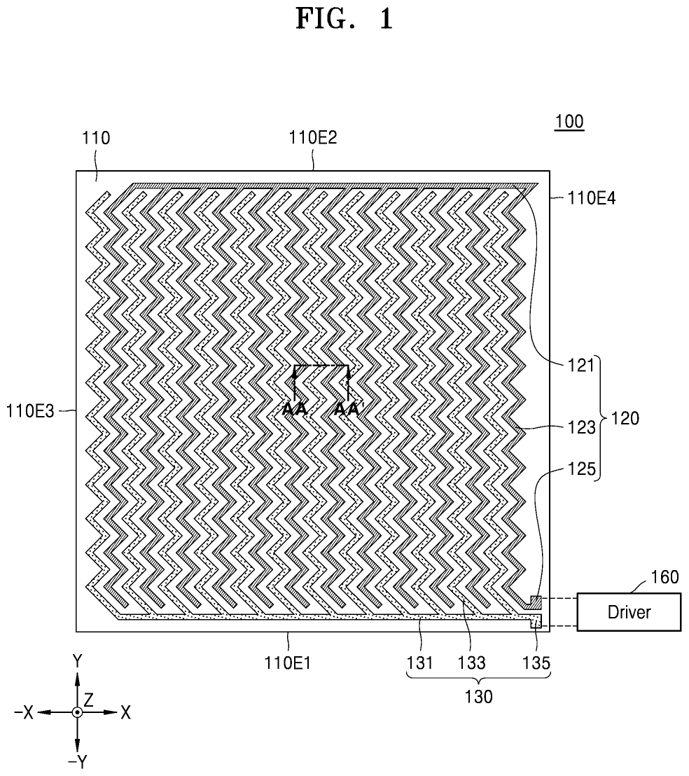

FIG. 1 is a plan view illustrating a phase grating liquid crystal (PGLC) device according to example embodiments.

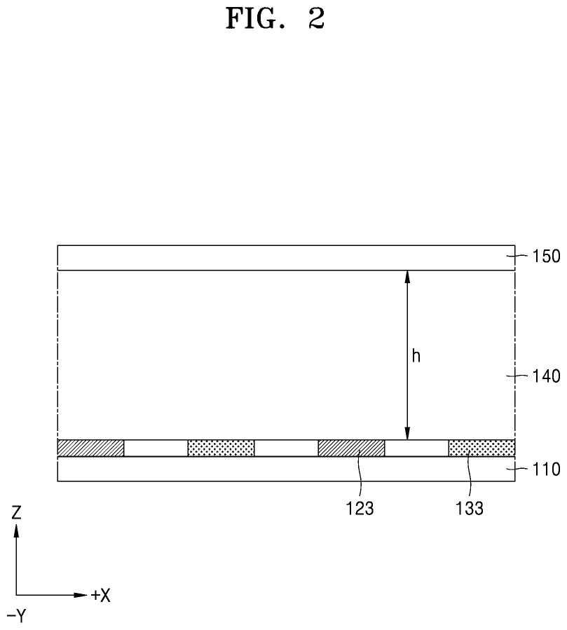

FIG. 2 is a cross-sectional view taken along the cut line AA-AA′ of FIG. 1.

Referring to FIG. 1 and FIG. 2, the PGLC device 100 may include a first transparent substrate 110, first and second electrodes 120 and 130 formed on the first transparent substrate 100, and a liquid crystal layer 140, a second transparent substrate 150 and a driving device 160.

According to example embodiments, the PGLC device 100 may include with only a single cell. The PGLC device 100 may be in a transparent state wherein light may pass therethrough over the entire surface, or may be in a hazy state wherein light is scattered at a wide angle over the entire surface. In the hazy state, the PGLC device 100 makes it impossible to recognize objects beyond the PGLC device 100. When power is not supplied to the PGLC device 100, the PGLC device 100 may be entirely a transparent layer, and when power is supplied to the PGLC device 100, the PGLC device 100 may be entirely a translucent layer.

According to example embodiments, when power is supplied to the PGLC device 100, the alignment direction of liquid crystal molecules in the liquid crystal layer 140 may periodically change with a position in a two-dimensional space (i.e., a position in ±X direction and a position in ±Y direction). That is, unlike liquid crystal display devices, liquid crystal molecules of the PGLC device 100 may have variable alignment directions within a single pixel. This is because the PGLC device 100 is intended not to block or pass the light passing through the PGLC device 100, but to scatter the light passing through the PGLC device 100 at a wide angle.

The first and second transparent substrates 110 and 150 may be transparent to a light in the visible band. Each of the first and second transparent substrates 110 and 150 may include an insulating material having high light transmittance, such as glass or polyimide. Each of the first and second transparent substrates 110 and 150 may have a substantially rectangular planar shape. The first transparent substrate 110 may include first and second edges 110E1 and 110E2 parallel to each other, and third and fourth edges 110E3 and 110E4 each connected to the first and second edges 110E1 and 110E2, and parallel to each other.

The direction from the third edge 110E3 to the fourth edge 110E4 is defined as a +X direction, the opposite direction is defined as a −X direction, and the direction from the first edge 110E1 to the second edge 110E2 is defined as a +Y direction and the opposite direction is defined as a −Y direction. The ±X direction may be parallel to the first and second edges 110E1 and 110E2, and the ±Y direction may be parallel to the third and fourth edges 110E3 and 110E4. A direction perpendicular to the upper surface of the first transparent substrate 110 is defined as the Z direction.

The first and second electrodes 120 and 130 may be arranged on the first transparent substrate 110. Each of the first and second electrodes 120 and 130 may contact the first transparent substrate 110. The first and second electrodes 120 and 130 may be arranged at the same level with respect to the first transparent substrate 110 in the Z direction. The first and second electrodes 120 and 130 may be spaced apart from each other. The first and second electrodes 120 and 130 may be electrically insulated from each other.

Each of the first and second electrodes 120 and 130 may be a transparent electrode. The first and second electrodes 120 and 130 may include, for example, a transparent and conductive material such as ITO (Indium Tin Oxide). The first and second electrodes 120 and 130 may be arranged substantially over the entire surface of the first transparent substrate 110. According to example embodiments, an area in which the first and second electrodes 120 and 130 are formed may be 80% or more of the area of the first transparent substrate 110. According to example embodiments, an area in which the first and second electrodes 120 and 130 are formed may be 90% or more of the area of the first transparent substrate 110. The area in which the first and second electrodes 120 and 130 are formed is defined as an area between the first and second bus lines 121 and 122.

The first electrode 120 may include a first bus line 121 extending in the ±X direction, a plurality of first branch electrodes 123 connected to the first bus line 121 and extending in the ±Y direction, and a first pad 125 connected to one of the plurality of first branch electrodes 123 (for example, the first branch electrode 123 closest to the fourth edge 110E4).

According to example embodiments, lengths of the plurality of first branch electrodes 123 in the ±Y direction may be substantially identical. According to example embodiments, lengths of the plurality of second branch electrodes 133 in the ±Y direction may be substantially identical. According to example embodiments, the lengths of the plurality of first branch electrodes 123 in the ±Y direction may be substantially the same as the lengths of the plurality of second branch electrodes 133 in the ±Y direction.

The second electrode 130 may include a second bus line 131 extending in the ±X direction, a plurality of second branch electrodes 133 connected to the second bus line 131 and extending in the ±Y direction, and a second pad 135 connected to the second bus line 131.

The first bus line 121 may be adjacent to the second edge 110E2, and the second bus line 131 may be adjacent to the first edge 110E1. The first bus line 121 may extend along a first portion (e.g., a second edge 110E2) of an edge of the first transparent substrate 110, and the second bus line 131 may extend along a second portion (e.g., the first edge 110E1) of the edge of the first transparent substrate 110.

The plurality of first branch electrodes 123 may extend from the first bus line 121 toward the second bus line 131. The plurality of second branch electrodes 133 may extend from the second bus line 131 toward the first bus line 121.

The plurality of first branch electrodes 123 and the plurality of second branch electrodes 133 may be alternately arranged along the ±X direction. For example, one of the second branch electrodes 133 may be disposed between two neighboring ones of the first branch electrodes 123, and one of the first branch electrodes 123 may be disposed between two neighboring ones of the second branch electrodes 133.

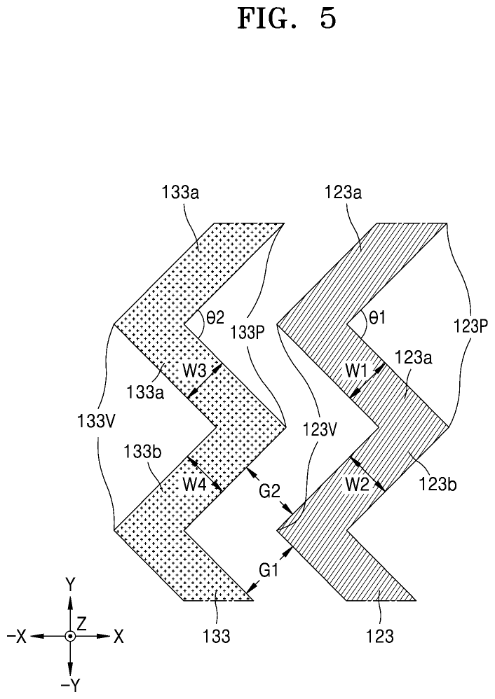

Each of the plurality of first branch electrodes 123 and the plurality of second branch electrodes 133 may have a triangular wave structure. The triangular wave structure of the plurality of first branch electrodes 123 and the plurality of second branch electrodes 133 will be described later with reference to FIG. 5.

The liquid crystal layer 140 may include liquid crystal molecules of which an alignment direction changes according to an applied electric field.

The driving device 160 may supply voltage to the first and second electrodes 120 and 130 through the first and second pads 125 and 135. For example, the driving device 160 may supply a positive supply voltage to the first electrode 120 and may supply a negative supply voltage lower than the positive supply voltage to the second electrode 130. In another example, the driving device 160 may supply a negative supply voltage to the first electrode 120 and a positive supply voltage to the second electrode 130.

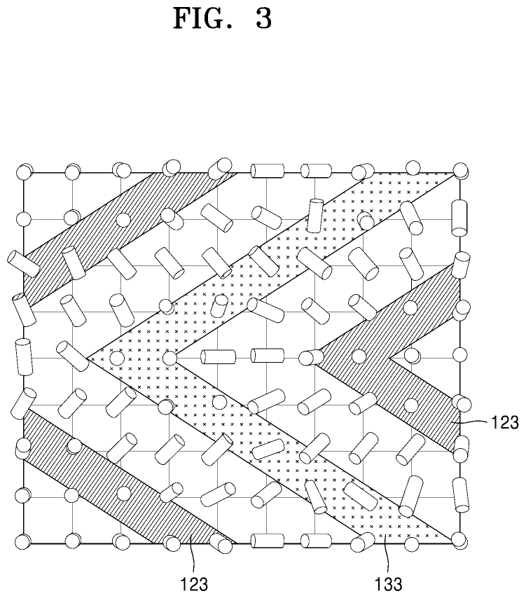

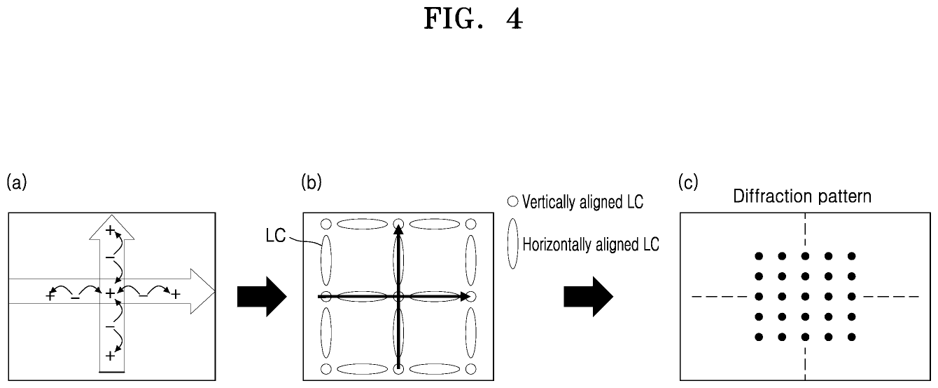

FIG. 3 and FIG. 4 are schematic drawings for explaining an operation mechanism of the PGLC device 100 according to example embodiments.

Referring to FIG. 1 and FIG. 3, since an overall structure of first and second electrodes 120 and 130 is periodic over the entire surface of the first transparent substrate 110, when power is supplied to the first and second electrodes 120 and 130, a distribution of the alignment directions of the liquid crystal molecules LC of the liquid crystal layer 140 may also have a spatial periodicity.

Referring to FIG. 1 and FIG. 4, (a) of FIG. 4 shows a periodic electric field formed in a space. When an electric field having a spatial periodicity as shown in (a) of FIG. 4 is applied to the liquid crystal layer 140, the spatial distribution of the alignment direction of the liquid crystal molecules has spatial periodicity as shown in (b) of FIG. 4. The periodic spatial distribution of the alignment direction of the liquid crystal molecules shown in (b) of FIG. 4 may scatter light passing through the liquid crystal layer 140 at a wide angle, and accordingly, the PGLC device 100 may be in a hazy state.

In conventional PGLC devices, the periodic distribution of alignment direction of the liquid crystal in the liquid crystal layer is implemented by electrodes formed on two different layers. However, when the PGLC device includes two different electrode layers, the manufacturing costs of the PGLC device are excessive.

According to example embodiments, the PGLC device 100 may include a plurality of first branch electrodes 123 and a plurality of second branch electrodes 133 formed from a single transparent electrode material layer.

Since each of the plurality of first branch electrodes 123 and the plurality of second branch electrodes 133 has a triangular wave structure and the plurality of first branch electrodes 123 and the plurality of second branch electrodes 133 are alternately arranged with each other, the alignment distribution of liquid crystal molecules of the liquid crystal layer 140 may have spatial periodicity.

According to example embodiments, the PGLC device 100 operating with the first and second electrodes 120 and 130 of a single layer may be provided, and the cost of manufacturing the PGLC device 100 may be reduced.

FIG. 5 is a partial plan view illustrating one of the plurality of first branch electrodes 123 and one of the plurality of second branch electrodes 133 according to example embodiments. For convenience of description, components of the PGLC device 100 other than the first and second branch electrodes 123 and 133 are omitted.

Referring to FIG. 5, each of the first branch electrode 123 may include first and second portions 123a and 123b alternately disposed with each other. The first portions 123a may be oblique to each of the ±X and ±Y directions, and the second portions 123b may be oblique to each of the ±X and ±Y directions.

According to example embodiments, the first portions 123a and the second portions 123b may be inclined to each other. For example, the first angle θ1 between the first portions 123a and the second portions 123b is greater than about 0°, less than about 90°, or greater than about 90°, and less than about 180°. According to example embodiments, the first portions 123a and the second portions 122b may be perpendicular to each other. For example, the first angle θ1 may be about 90°.

Each of the first portions 123a may be connected to two neighboring ones of the second portions 123b, and each of the second portions 123b may be connected to two neighboring ones of the first portions 123a. The first branch electrode 123 may include a plurality of first peaks 123P and a plurality of first valleys 123 due to the first portions 123a and the second portions 123b that are alternately arranged and connected to each other.

The plurality of first peaks 123P are maxima in the +X direction of the first branch electrode 123, and the plurality of first valleys 123V are maxima in the −X direction of the first branch electrode 123. According to example embodiments, the plurality of first peaks 123P included in one of the first branch electrode 123 may be aligned in the ±Y direction. According to example embodiments, the plurality of first valleys 123V included in one of the first branch electrode 123 may be aligned in the ±Y direction.

Each of the second branch electrode 133 may include third and fourth portions 133a and 133b alternately disposed with each other. The third portions 133a may be oblique to each of the ±X and ±Y directions, and the fourth portions 133b may be oblique to each of the ±X and ±Y directions.

According to example embodiments, the third portions 133a and the fourth portions 133b may be inclined with respect to each other. For example, the second angle θ2 between the third portions 133a and the fourth portions 133b is greater than about 0° and less than about 90°, or greater than about 90°, and less than about 180º. According to example embodiments, the third portions 133a and the fourth portions 133b may be perpendicular to each other. For example, the second angle θ2 may be about 90°.

Each of the third portions 133a may be connected to two neighboring ones of the fourth portions 133b, and each of the fourth portions 133b may be connected to two neighboring ones of the third portions 133a. The second branch electrode 133 may include a plurality of second peaks 133P and a plurality of second valleys 133V due to the third portions 133a and the fourth portions 133b that are alternately arranged and connected to each other.

The plurality of second peaks 133P are maxima in the +X direction of the second branch electrode 133, and the plurality of second valleys 133V are maxima in the −X direction of the second branch electrode 133. According to example embodiments, a plurality of second peaks 133P of one of the second branch electrode 133 may be aligned in the ±Y direction. According to example embodiments, a plurality of second valleys 133V of one of the second branch electrode 133 may be aligned in the ±Y direction.

The plurality of first peaks 123P and the plurality of second peaks 133P are may be aligned in the ±X direction. The plurality of first valleys 123V and the plurality of second valleys 133V are may be aligned in the ±X direction.

The first gap G1 may be the shortest distance between one of the first portions 123a and neighboring one of the third portions 133a. The first gap G1 is, for example, a distance in a direction perpendicular to the edges of each of the first and third portions 123a and 133a. The second gap G2 may be the shortest distance between one of the second portions 123b and neighboring one of the fourth portions 133b. The second gap G2 is, for example, a distance in a direction perpendicular to the edges of each of the second and fourth portions 123b and 133b. According to example embodiments, the first and second gaps G1 and G2 may be the same.

The first portions 123a may have a first width W1, the second portions 123b may have a second width W2, and the third portions 133a may have a third width W3, and the fourth portions 133b may have a fourth width W4. According to example embodiments, the first to fourth widths W1, W2, W3, and W4 may be the same.

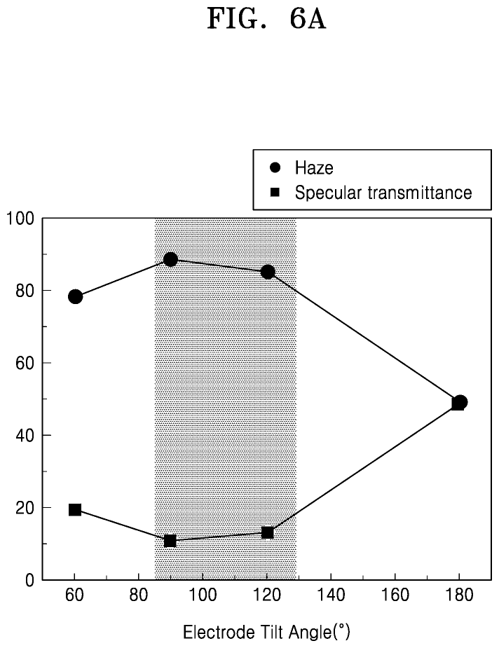

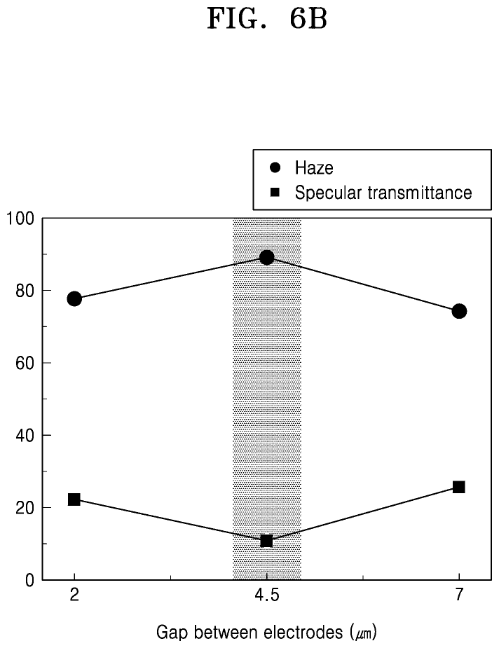

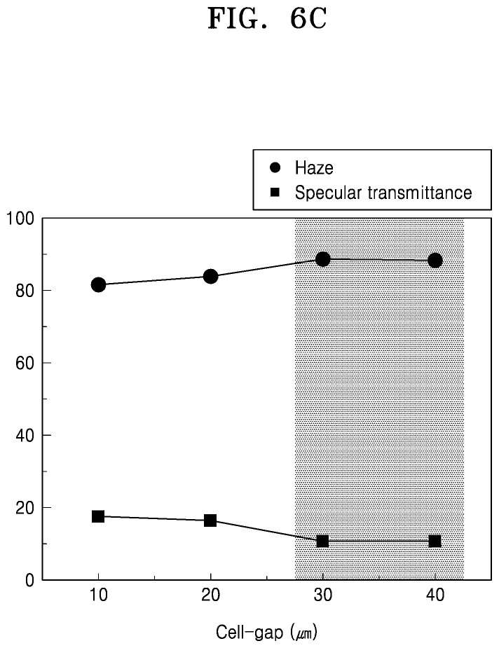

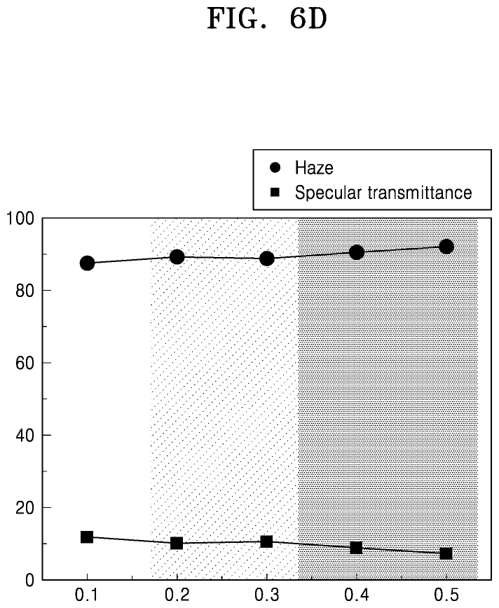

FIGS. 6A to 6D are graphs for explaining effects according to dimensions of the first and second branch electrodes 123 and 133 and liquid crystal layer 140 according to example embodiments.

FIG. 6A illustrates the specular transmittance and the haze of the PGLC device 100 (see FIG. 1) to which power is applied according to the change of the first and second angles θ1 and 02 (see FIG. 5). In the experimental examples of FIG. 6A, the first and second angles θ1 and 02 are the same.

Referring to FIGS. 1, 3, and 6A, when each of the first and second angles θ1 and 02 was in the range of about 60° to about 130°, the haze the PGLC device 100 was 80% or more, and the specular transmittance of the PGLC device 100 was 20% or less. In particular, when each of the first and second angles θ1 and 02 was about 90°, the haze of the PGLC device 100 was maximum and the specular transmittance of the PGLC device 100 was minimum.

According to example embodiments, when each of the first and second angles θ1 and θ2 are about 90°, the first and second portions 123a and 123b are perpendicular to each other, and the first and second angles 133a and 133b are perpendicular to each other. Accordingly, an electric field distribution having substantially the same period along two orthogonal axes may be realized, and the haze performance of the PGLC device 100 may be maximized.

FIG. 6B illustrates specular transmittance and the haze of the PGLC device 100 (see FIG. 1) to which power is applied according to the change of the first and second intervals G1 and G2. In the experimental examples of FIG. 6B, the first and second intervals G1 and G2 were the same, and the first to fourth widths W1, W2, W3, and W4 (see, FIG. 5) were about 2 μm.

Referring to FIGS. 1, 5, and 6B, when each of the first and second intervals G1 and G2 ranged from about 2 μm to about 7 μm, the haze of the PGLC device 100 was 75% or more, and the specular transmittance of the PGLC device 100 was about 25% or less. In particular, when each of the first and second intervals G1 and G2 was about 4.5 μm, it was confirmed that the haze of PGLC device is maximum and the specular transmittance is minimum.

In addition, according to the experimental example, when the sum of one of the first and second intervals G1 and G2 and one of the first to fourth widths W1, W2, W3, and W4 was about 30 μm, first-order diffraction angle of PGLC device was about 0.5°, and when the sum of one of the first and second intervals G1 and G2 and one of the first to fourth widths W1, W2, W3, and W4 was about 6 μm, first-order diffraction angle of PGLC device was about 3°.

The hazy state is implemented under a condition of wide first-order diffraction angle of about 2.5° or more. According to example embodiments, by providing PGLC device 100 with a small sum (e.g., about 1 μm to about 10 μm) of one of the first and second intervals G1 and G2 and one of the first to fourth widths W1, W2, W3, and W4, the haze performance of the PGLC device 100 may be improved.

FIG. 6C illustrates the specular transmittance and the haze of the PGLC device 100 (see FIG. 1) to which power is applied according to the height h of the liquid crystal layer 140 in FIG. 2.

Referring to FIGS. 1, 2 and 6B, when the height h was in the range of about 10 μm to about 40 μm, the haze of the PGLC device 100 was about 80% or more, and the specular transmittance of the PGLC device 100 was about 20% or less. According to the experimental examples, it was confirmed that as the height h increases, the haze of the PGLC device 100 increases and the specular transmittance of the PGLC device 100 decreases.

FIG. 6D illustrates the specular transmittance and haze of the PGLC device 100 (refer to FIG. 1) to which power is applied according to the magnitude of birefringence of liquid crystal molecules included in the liquid crystal layer 140 of FIG. 2.

The birefringence A is defined as the difference between the refractive index of the liquid crystal molecules with respect to the extra ordinary ray ne and the refractive index of the liquid crystal molecules with respect to the ordinary ray no. The extraordinary ray may pass through the liquid crystal molecules vertically (i.e., along the optical axis of the liquid crystal molecules), and the ordinary ray may pass through liquid crystal molecules horizontally.

According to the experimental example, when the birefringence A was 0.1 or more, the haze of the PGLC device 100 was about 85% or more and the specular transmittance of the PGLC device 100 was about 15% or less.

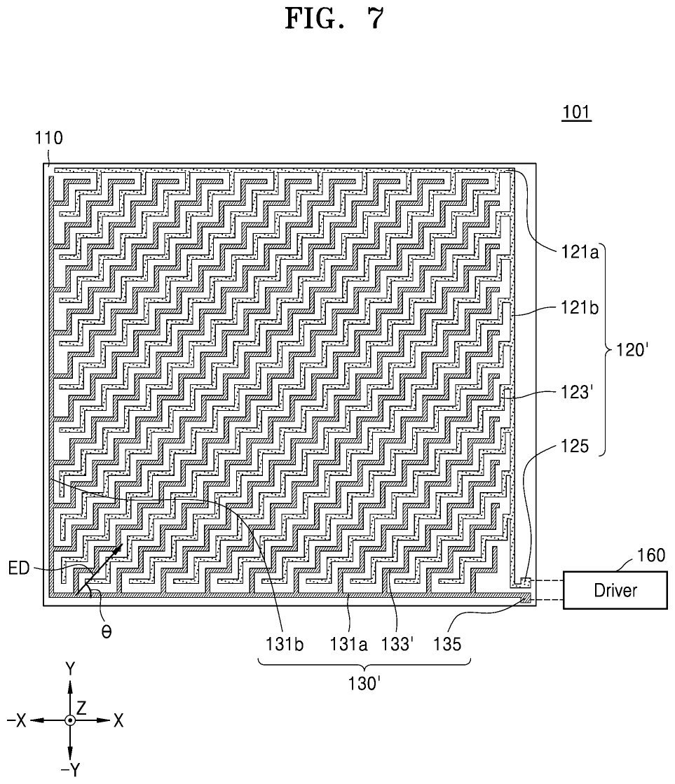

FIG. 7 is a plan view illustrating a PGLC device 101 according to other example embodiments.

For convenience of description, repetition of the features described with reference to FIGS. 1 to 6D will be omitted and only the differences will be mainly described.

Referring to FIG. 7, the PGLC device 101 may include a first transparent substrate 110, first and second electrodes 120′ and 130′, and a driving device 160.

The PGLC device 101 may further include a liquid crystal layer 140 and a second transparent substrate 150, similarly to the PGLC device 100 illustrated in FIGS. 1 and 2.

The first electrode 120′ may include first and second bus lines 121a and 121b, a plurality of first branch electrodes 123′, and a first pad 125. The second electrode 130′ may include third and fourth bus lines 131a and 131b, a plurality of second branch electrodes 133′, and a second pad 135.

According to example embodiments, the first and third bus lines 121a and 131a may extend along the ±X direction. According to example embodiments, the second and fourth bus lines 121b and 131b may extend along the ±Y direction. According to example embodiments, the first bus line 121a and the second bus line 121b may be connected to each other, and the third bus line 131a and the fourth bus line 131b may be connected to each other

According to example embodiments, the first to fourth bus lines 121a, 121b, 131a, 131b may horizontally surround an approximately rectangular area. According to example embodiments, the plurality of first branch electrodes 123′ and the plurality of second branch electrodes 133′ may be surrounded by the first to fourth bus lines 121a, 121b, 131a, 131b.

According to example embodiments, the extension directions ED of the plurality of first branch electrodes 123′ and the plurality of second branch electrodes 133′ may be oblique with respect to the ±X direction and the ±Y direction. The extension direction ED of the plurality of first branch electrodes 123′ and the plurality of second branch electrodes 133′ may be an alignment direction of the plurality of peaks and valleys defined similarly to FIG. 5. In the embodiment shown in FIG. 5, maxima in the ±X direction are defined as a plurality of peaks and a plurality of valleys. However, maxima of the plurality of first branch electrodes 123′ and the plurality of second branch electrodes 133′ in a direction perpendicular to the extension direction ED are defined as peaks and valleys. According to example embodiments, the extension direction ED of the plurality of first branch electrodes 123′ and the plurality of second branch electrodes 133′ may be inclined by an angle φ with respect to the +X direction. According to example embodiments, the angle φ may be greater than 0 degrees and less than 90 degrees.

According to example embodiments, an extension direction ED of each of the plurality of first branch electrodes 123′ and the plurality of second branch electrodes 133′ may be inclined at an arbitrary angle with respect to the edges of the first transparent substrate 110. Accordingly, the degree of freedom in designing the PGLC device 101 may be improved.

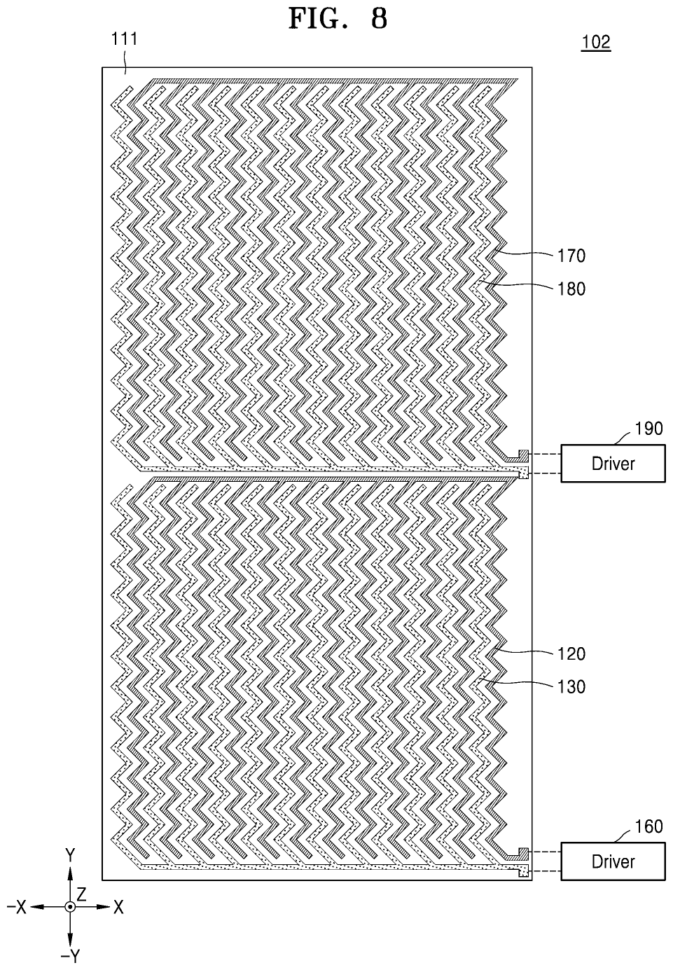

FIG. 8 is a plan view illustrating the PGLC device 102 according to other example embodiments.

For convenience of description, repetition of the features described with reference to FIGS. 1 to 6D will be omitted and only the differences will be mainly described.

Referring to FIG. 8, the PGLC device 102 may include a first transparent substrate 111, first to fourth electrodes 120, 130, 170, 180, and driving devices 160 and 190. The PGLC device 102 may further include a liquid crystal layer and a second transparent substrate, similarly to the PGLC device 100 shown in FIGS. 1 and 2.

The first and second electrodes 120 and 130 are substantially the same as those described with reference to FIG. 1. The third and fourth electrodes 170 and 180 are similar to the first and second electrodes 120 and 130 described with reference to FIG. 1. The third and fourth electrodes 170 and 180 may cover a portion of the first transparent substrate 111 different from a portion of the first transparent substrate 111 covered by the first and second electrodes 120 and 130. The third and fourth electrodes 170 and 180 may be separately driven by the driving device 190.

According to example embodiments, the PGLC device 102 may include a first pixel defined by the first and second electrodes 120 and 130 and a second pixel defined by the third and fourth electrodes 170 and 180. The first and second pixels may operate separately from each other. For example, the first pixel may be in a hazy state and the second pixel may be in a transparent state, or the first pixel may be in a transparent state and the second pixel may be in a hazy state. Also, the first and second pixels may be in a transparent state at the same time or may be in a hazy state at the same time.

According to other example embodiments, the driving device 190 may be omitted from the PGLC device 102, and the first to fourth electrodes may be controlled by the driving device 160. A person skilled in the art will be able to easily design a PGLC device including three or more pixels operating separately, based on the above description.

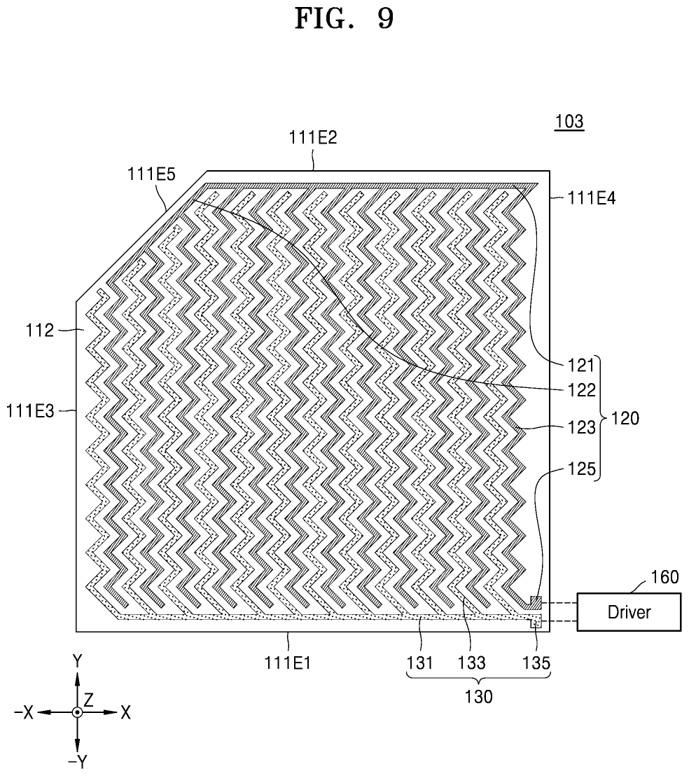

FIG. 9 is a plan view illustrating a PGLC device 103 according to other example embodiments.

For convenience of description, repetition of the features described with reference to FIGS. 1 to 6D will be omitted and only the differences will be mainly described.

Referring to FIG. 9, the PGLC device 103 may include a first transparent substrate 112, first and second electrodes 120″ and 130″, and a driving device 160. The PGLC device 103 may further include a liquid crystal layer and a second transparent substrate, similarly to the PGLC device 100 shown in FIGS. 1 and 2.

According to example embodiments, the first transparent substrate 112 may have a pentagonal planar shape. The first transparent substrate 112 may include first and second edges 111E1 and 111E2 extending in the ±X direction, and third and fourth edges 111E3 and 111E4 extending in the ±Y direction. The first transparent substrate 112 may further include fifth edges 111E5 connected to the third edges 111E2 and 111E3 and oblique with respect to each of the ±X and ±Y directions.

According to exemplary embodiments, the liquid crystal layer and the second transparent substrate included in the PGLC device 103 may also have substantially the same planar shape as the first transparent substrate 112.

According to example embodiments, the first electrode 120″ may include a first bus line 121 extending in the ±X direction, a first bus line 122 adjacent to the fifth edge 111E5 and extending along the fifth edge 111E5, a plurality of first branch electrodes 123 connected to one of the first bus lines 121 and 122 and extending in the ±Y direction, and a first pad 125 connected to one of the plurality of first branch electrodes 123.

According to example embodiments, some of the first and second branch electrodes 123 and 133 interposed between the first bus line 122 and the second bus line 133 may have shorter length than some of the first and second branch electrodes 123 and 133 interposed between the first bus line 121 and the second bus line 133. According to example embodiments, the first and second electrodes 120″ and 130 may cover the entire surface of the first transparent substrate 112.

A person skilled in the art will be able to easily design the PGLC device 103 having any polygonal shape other than a pentagon, based on the above description. According to example embodiments, it is possible to provide the PGLC device 103 of various planar shapes, and accordingly, the degree of freedom in choosing an application (e.g., a conference room wall, etc.) of the PGLC device 103 may be improved.

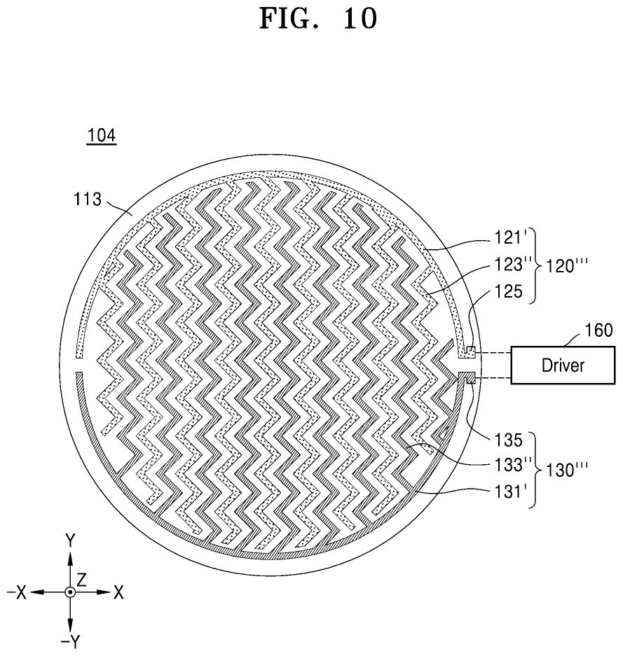

FIG. 10 is a plan view illustrating a PGLC device 104 according to other example embodiments.

For convenience of description, repetition of the features described with reference to FIGS. 1 to 6D will be omitted and only the differences will be mainly described.

Referring to FIG. 10, the PGLC device 104 may include a first transparent substrate 113, first and second electrodes 120′″ and 130′″, and a driving device 160. The PGLC device 104 may further include a liquid crystal layer and a second transparent substrate, similarly to the PGLC device 100 shown in FIGS. 1 and 2.

According to example embodiments, the first transparent substrate 113 may have a circular planar shape. According to example embodiments, the liquid crystal layer and the second transparent substrate included in the PGLC device 104 may also have substantially the same planar shape as that of the first transparent substrate 113.

According to example embodiments, the first electrode 120′″ may include a first bus line 121′ extending along an outline of the first transparent substrate 113, a plurality of first branch electrodes 123 connected to the first bus line 121′ and extending in the ±Y direction and a first pad 125 connected to the first bus line 121′.

According to example embodiments, the second electrode 130′″ may include a second bus line 131′ extending along the outline of the first transparent substrate 113, a plurality of second branch electrodes 133 connected to the second bus line 131′ and extending in the ±Y direction and a second pad 135 connected to the second bus line 131′.

According to example embodiments, the first and second electrodes 120′″ and 130′″ may cover the entire surface of the first transparent substrate 113 together. A person skilled in the art will be able to easily design a PGLC device comprising a transparent substrate having any planar shape including various curved edges based on the above description.

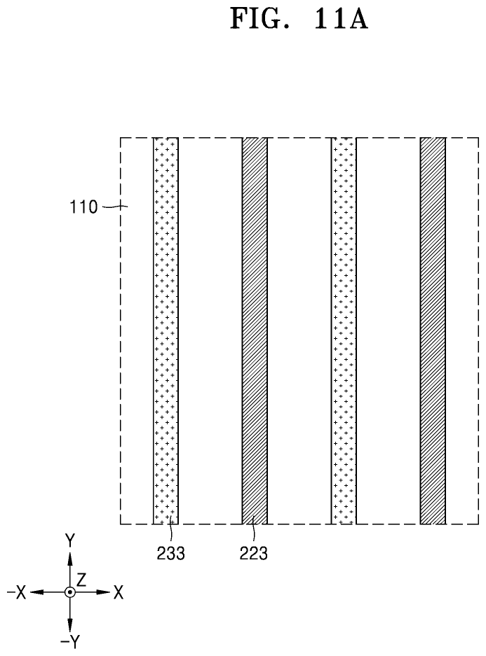

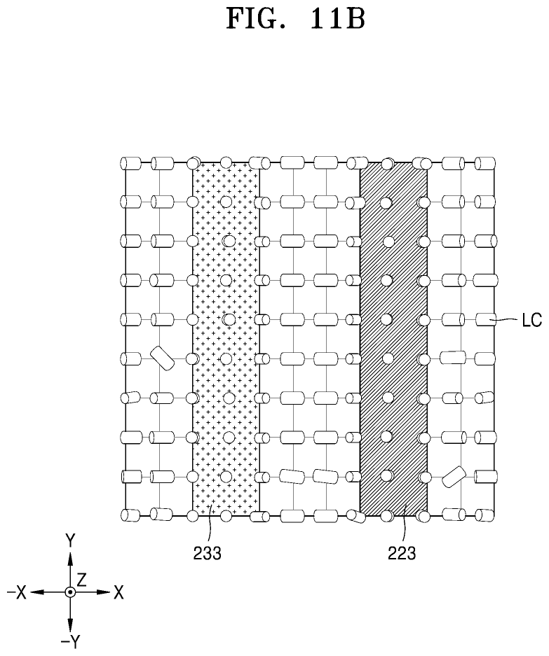

FIG. 11A is a partial plan view illustrating a plurality of first branch electrodes 223 and a plurality of second branch electrodes 233 according to other example embodiments.

FIG. 11B illustrates distribution of alignment directions of liquid crystal molecules included in the liquid crystal layer 140 (see FIG. 2) when power is applied to the plurality of first branch electrodes 223 and the plurality of second branch electrodes 233.

Referring to FIG. 11A, each of the plurality of first branch electrodes 223 and the plurality of second branch electrodes 233 may have a line shape extending in the ±Y direction.

In this case, an electric field from the first branch electrodes 223 toward the second branch electrode 233 adjacent to the first branch electrodes 223 is formed. That is, the electric field may periodically change in the ±X direction and may be substantially constant in the ±Y direction.

Referring to FIG. 11B, accordingly, the distribution of the alignment direction of the liquid crystal is periodic along ±X, but does not substantially change along the ±Y direction.

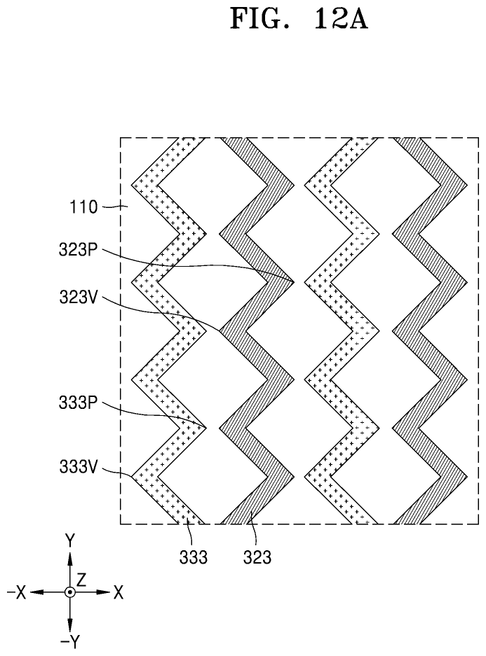

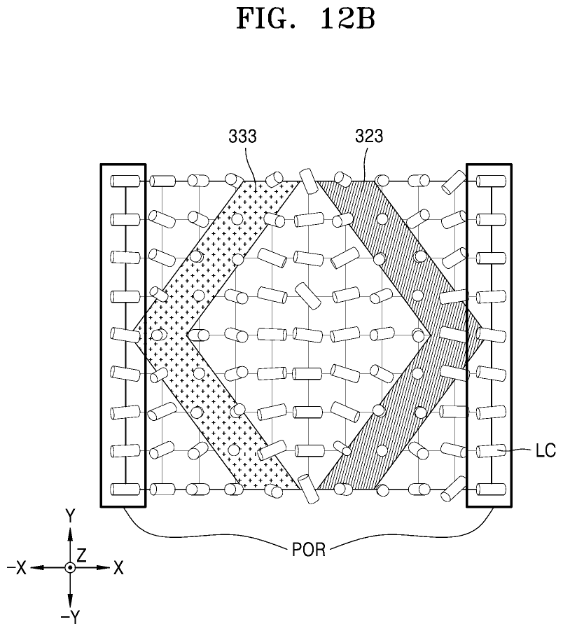

FIG. 12A is a partial plan view illustrating a plurality of first branch electrodes 323 and a plurality of second branch electrodes 333 according to other example embodiments.

FIG. 12B illustrates a distribution of alignment directions of liquid crystal molecules included in the liquid crystal layer 140 (see FIG. 2) when power is applied to the plurality of first branch electrodes 323 and the plurality of second branch electrodes 333

Referring to FIG. 12A, each of the plurality of first branch electrodes 323 and the plurality of second branch electrodes 333 may have a triangular wave shape extending in the ±Y direction, similarly to the plurality of first branch electrodes 123 and the plurality of second branch electrodes 133 of FIG. 1. The plurality of first branch electrodes 323 and the plurality of second branch electrodes 333 may include peaks and valleys 323P, 323V, 333P, and 333V staggered to each other. More specifically, a plurality of peaks 323P of the first branch electrodes 323 are aligned with a plurality of valleys 333V of the second branch electrodes 333 in the ±X direction, and a plurality of valleys 323V of the first branch electrodes 323 may be aligned with a plurality of peaks 333P of the second branch electrodes 333 in the ±X direction.

According to example embodiments, since each of the plurality of first and second branch electrodes 323 and 333 have a triangular wave shape, each of the plurality of first and second branch electrodes 323 and 333 may include portions extending in different directions (e.g., orthogonal direction). Accordingly, an electric field that periodically changes along two dimensional axes may be applied over the entire surface of the first transparent substrate 110 based on the plurality of first branch electrodes 323 and the plurality of second branch electrodes 333 of a single layer.

Referring to FIG. 12B, it was confirmed that the alignment direction of the liquid crystal molecules periodically changes over the entire surface of the first transparent substrate 110 except for line-shaped portions POR extending in the ±Y direction and interposed between the plurality of first branch electrodes 323 and the plurality of second branch electrodes and 333.

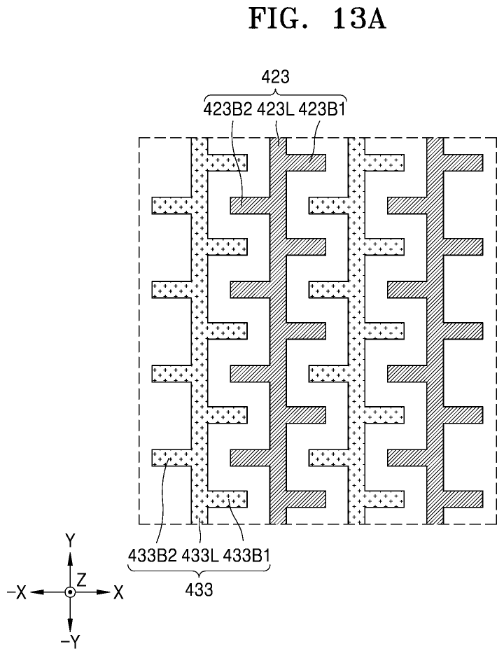

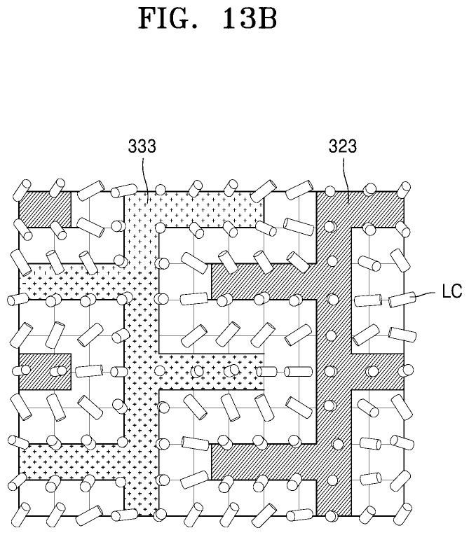

FIG. 13A is a partial plan view illustrating a plurality of first branch electrodes 423 and a plurality of second branch electrodes 433 according to other example embodiments.

FIG. 13B illustrates a distribution of alignment directions of liquid crystal molecules included in the liquid crystal layer 140 (see FIG. 2) when power is applied to the plurality of first branch electrodes 423 and the plurality of second branch electrodes 433 according to other example embodiments.

Referring to FIG. 13A, each of the plurality of first branch electrodes 423 and the plurality of second branch electrodes 433 may include a comb structure in both directions (i.e., in the +X direction and the −X direction).

Each of the plurality of first branch electrodes 423 may include a first line portion 423L extending in the ±Y direction, a first branch portions 423B1 extending from the first line part 423L in the +X direction, and a second branch portions 423B2 extending in the −X direction from the first line portion 423L.

Each of the plurality of second branch electrodes 433 may include a second line portion 433L extending in the ±Y direction, a third branch portions 433B1 extending in the +X direction from the second line portion 433L, and fourth branch portions 433B2 extending in the −X direction from the second line portion 433L.

According to example embodiments, the first branch portions 423B1 and the second branch portions 423B2 included in one of the first branch electrodes 423 may be alternately disposed. For example, one of the second branch portions 423B2 may be disposed between two neighboring ones of the first branch portions 423B1, and one of the first branch portions 423B1 may be disposed between two neighboring ones of the second branch portions 423B2.

According to example embodiments, the third branch portions 433B1 and the fourth branch portions 433B2 included in one of the second branch electrodes 433 may be alternately disposed. For example, one of the fourth branch portions 433B2 may be disposed between two neighboring ones of the third branch portions 433B1, and one of the third branch portion 433B1 may be disposed between two neighboring ones of the fourth branch portions 433B2.

According to example embodiments, one of the fourth branch portions 433B2 may be disposed between two neighboring ones of the first branch portions 423B1, and one of the first branch portions 423B1 may be disposed between two neighboring ones of the fourth branch portions 433B2.

According to example embodiments, one of the third branch portions 433B1 may be disposed between two neighboring ones of the second branch portions 423B2, and one of the second branch portions 423B2 may be disposed between two neighboring ones of the third branch portions 433B1.

According to example embodiments, each of the plurality of first branch electrodes 423 and the plurality of second branch electrodes 433 may include first and second line portions 423L and 433L extending in the ±Y direction, and first to fourth branch portions 423B1, 423B2, 433B1, and 433B2 extending in the ±X direction. Accordingly, each of the plurality of first branch electrodes 423 and the plurality of second branch electrodes 433 may include portions extending in different directions (e.g., orthogonal directions). Accordingly, an electric field that periodically changes along two orthogonal axes may be applied over the entire surface of the first transparent substrate 110 based on the first and second branch electrodes 423 and 433 of a single layer.

Referring to FIG. 13B, it was confirmed that the alignment direction of the liquid crystal periodically changes over the entire surface of the transparent substrate 110 except for portions vertically overlapping the each of the plurality of first branch electrodes 423 and the plurality of second branch electrodes 433.

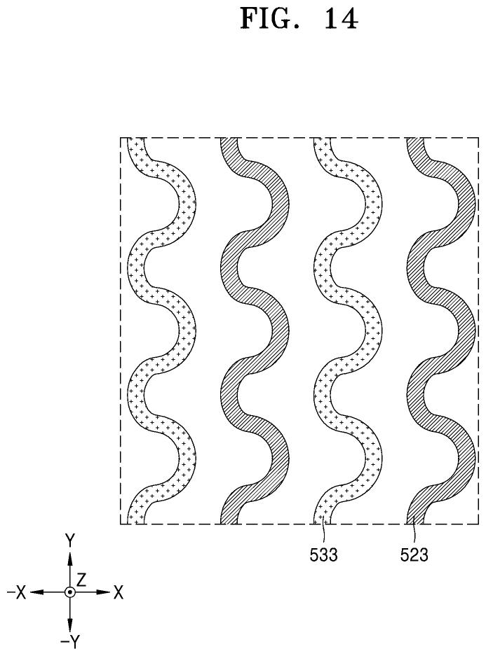

FIG. 14 is a plan view illustrating portions of a plurality of first branch electrodes 523 and a plurality of second branch electrodes 533 according to other example embodiments.

Referring to FIG. 14, each of the plurality of first branch electrodes 523 and the plurality of second branch electrodes 533 may have a wavy structure. According to example embodiments, each of the plurality of first branch electrodes 523 and the plurality of second branch electrodes 533 may include a curved portion.

Since each of the plurality of first branch electrodes 523 and the plurality of second branch electrodes 533 includes curved portions, each of the plurality of first branch electrodes 523 and the plurality of second branch electrodes 533 may periodically and continuously change two-dimensionally. Accordingly, when power is applied to the plurality of first branch electrodes 523 and the plurality of second branch electrodes 533, an electric field periodically changing over the entire surface of the first transparent substrate 110 may be provided. Accordingly, the haze performance of the PGLC device may be improved.

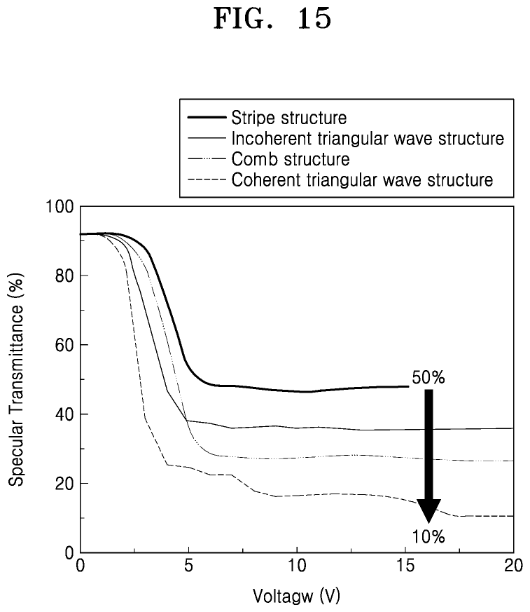

FIG. 15 illustrates a change in haze according to the magnitude of the voltage applied between the first and second branch electrodes 123 and 133 in FIG. 5, the first and second branch electrodes 223 and 233 in FIG. 11A, and the first and second branch electrodes 323 and 333 in FIG. 12A and the first and second branch electrodes 423 and 433 in FIG. 13A.

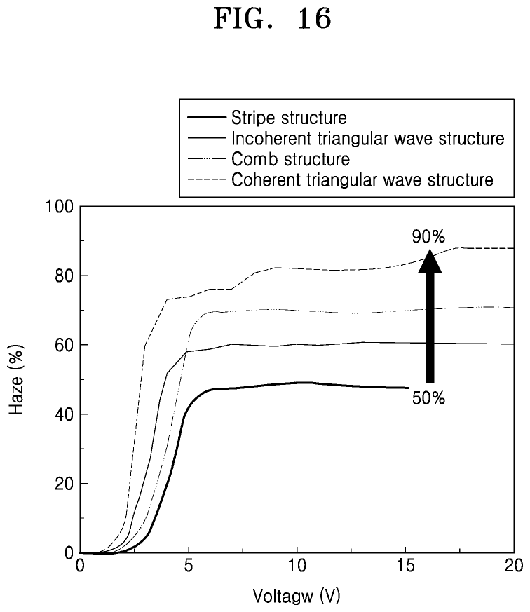

FIG. 16 illustrates a change in specular transmittance according to the magnitude of the voltage applied between the first and second branch electrodes 123 and 133 in FIG. 5, the first and second branch electrodes 223 and 233 in FIG. 11A, and the first and second branch electrodes 323 and 333 in FIG. 12A and the first and second branch electrodes 423 and 433 in FIG. 13A.

In FIGS. 15 and 16, graphs corresponding to the first and second branch electrodes 123 and 133 in FIG. 5 are denoted by a coherent triangular wave structure, graphs corresponding to the first and second branch electrodes 223 and 233 in FIG. 11A are denoted by a stripe structure, graphs corresponding to the first and second branch electrodes 323 and 333 in FIG. 12A are denoted by an incoherent triangular wave structure, and graphs corresponding to the first and second branch electrodes 423 and 433 in FIG. 13A is denoted by a comb structure.

Referring to FIGS. 15 and 16, when a voltage of 5V or more was applied, it was confirmed that the coherent triangular wave structure had the greatest haze and the smallest specular transmittance, and thus, the PGLC device of the coherent triangular wave structure had the best performance. In addition, when a voltage of 5V or more was applied, it was confirmed that the comb structure had better performance than the incoherent triangular wave structure, and that the incoherent triangular wave structure had better performance than the striped structure.

According to example embodiments, a structure of a branch electrode included in the PGLC device may be selected according to product specifications (e.g., a target haze and specular transmittance).

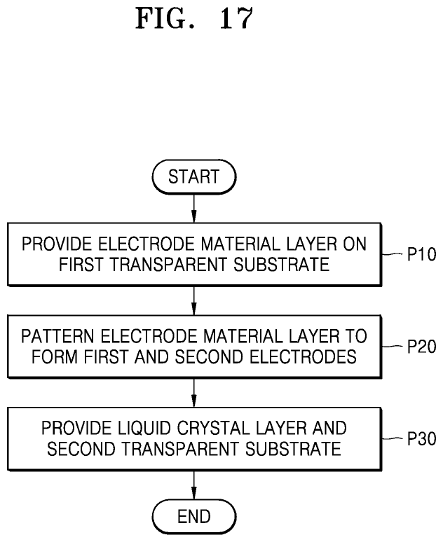

FIG. 17 is a flowchart illustrating a method of manufacturing a PGLC device according to example embodiments.

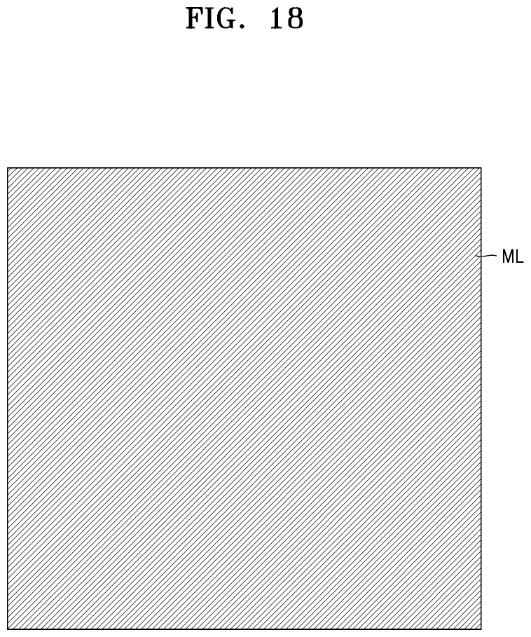

FIG. 18 is a plan view illustrating a method of manufacturing a PGLC device according to example embodiments.

Referring to the FIGS. 17 and 18, an electrode material layer ML may be provided on the first transparent substrate 110 at P10 (see FIG. 1).

The electrode material layer ML may be formed by, for example, chemical vapor deposition (CVD) and atomic layer deposition (ALD). The electrode material layer ML may include, for example, a transparent electrode material such as ITO.

Subsequently, the electrode material layer ML may be patterned to form the first and second electrodes at P20. The electrode material layer ML may be patterned by, for example, a metal lithography process. The first and second electrodes may include first and second bus lines 121 and 131 and first and second pads 125 and 135 illustrated in FIG. 1. The first and second electrodes are the first and second branch electrodes 123, 133, 223, 233, 323, 333, 423, 433, 523, and 533 described with reference to FIGS. 5, 11A, 12A, 13A, and 14.

Subsequently, referring to FIGS. 2 and 17, the liquid crystal layer 140 and the second transparent substrate 150 may be provided at P30. According to example embodiments, a PGLC device may be manufactured by a single deposition process of an electrode material layer and a single metal patterning process. Accordingly, the manufacturing cost of the PGLC device may be reduced.

While the inventive concept has been particularly shown and described with reference to embodiments thereof, it will be understood that various changes in form and details may be made therein without departing from the spirit and scope of the following claims.

1. A phase grating liquid crystal (PGLC) device comprising:
a transparent substrate;
a first electrode on the transparent substrate;
a second electrode on the transparent substrate; and
a liquid crystal (LC) layer on the first and second electrodes;
wherein the first electrode includes a first bus line extending in a first direction parallel to an upper surface of the transparent substrate, and a plurality of first branch electrodes connected to the first bus line,
wherein the second electrode includes a second bus line extending in the first direction, and a plurality of second branch electrodes connected to the second bus line, and
wherein the first and second electrodes are at the same level with respect to the transparent substrate.

2. The PGLC device of claim 1,
wherein the first and second electrodes are configured to form a periodic electric field over the entire transparent substrate.

3. The PGLC device of claim 1,
wherein the first and second electrodes are configured to form a periodic liquid crystal alignment distribution over the liquid crystal layer.

4. The PGLC device of claim 1,
wherein a first supply voltage is applied to the first electrode, and a second supply voltage less than the first voltage is applied to the second electrode.

5. The PGLC device of claim 4,
wherein the PGLC device is in a hazy state by applying the first and second power voltages.

6. The PGLC device of claim 1,
wherein each of the first and second electrodes contacts the transparent substrate.

7. The PGLC device of claim 1,
wherein the first and second bus lines are spaced apart from each other with the plurality of first branch electrodes and the plurality of second branch electrodes interposed therebetween.

8. The PGLC device of claim 1,
wherein the PGLC device include only a single cell composed of the first and second electrodes.

9. The PGLC device of claim 1,
wherein each of the plurality of first branch electrodes and the plurality of second branch electrodes extends along a second direction perpendicular to the first direction and parallel to an upper surface of the transparent substrate, and
wherein the plurality of first branch electrodes and the plurality of second branch electrodes are alternately arranged along the first direction.

10. The PGLC device of claim 9,
wherein the transparent substrate includes a straight edge oblique with respect to the second direction.

11. The PGLC device of claim 9,
wherein the transparent substrate includes a straight edge perpendicular to the second direction.

12. The PGLC device of claim 1,
wherein each of the plurality of first branch electrodes and the plurality of second branch electrodes has a triangular wave structure.

13. The PGLC device of claim 1,
wherein each of the plurality of first branch electrodes and each of the plurality of second branch electrodes has a comb structure.

14. The PGLC device of claim 1,
wherein each of the plurality of first branch electrodes and each of the plurality of second branch electrodes has a wavy structure.

15. The PGLC device of claim 1,
wherein each of the plurality of first branch electrodes includes first portions and second portions alternately connected to each other, and
wherein the first portions and the second portions are oblique with respect to each other.

16. The PGLC device of claim 1,
wherein each of the plurality of first branch electrodes includes first portions and second portions alternately connected to each other, and
wherein the first portions and second portions are perpendicular to each other.

17. A method of manufacturing a phase grating liquid crystal device (PGLC), the method comprising:
depositing a transparent electrode material layer on a transparent substrate; and
patterning, through a metal lithography process, the transparent electrode material layer to form first and second electrodes,
wherein the first electrode includes a first bus line extending in a first direction parallel to an upper surface of the transparent substrate, and a plurality of first branch electrodes connected to the first bus line, and
wherein the second electrode includes a second bus line extending in the first direction, and a plurality of second branch electrodes connected to the second bus line.

18. The method of claim 17,
wherein the first and second electrodes are formed simultaneously.

19. The method of claim 17,
wherein each of the plurality of first branch electrodes and each of the plurality of second branch electrodes extends along a second direction perpendicular to the first direction and parallel to an upper surface of the transparent substrate, and
wherein the plurality of first branch electrodes and the plurality of second branch electrodes are alternately arranged along the first direction.

20. The method of claim 17,
wherein each of the plurality of first branch electrodes and each of the plurality of second branch electrodes has a triangular wave.

21.-26. (canceled)
